(19) United States
(12) Patent Application Publication
(10) Pub. No.: US 2010/0131661 A1
(43) Pub. Date: May 27, 2010

(54) FIBER CHANNEL STORAGE SERVER

(75) Inventors: Peng Chen, Tianjin (CN); Tom Chen, Taipei (TW)

Correspondence Address: APEX JURIS, PLLC, 12733 LAKE CITY WAY NORTHEAST, SEATTLE, WA, 98125, US

(73) Assignee: INVENTEC COPRPORATION, Taipei (TW)

(21) Appl. No.: 12/324,101

(22) Filed: Nov. 26, 2008

(51) Int. Cl. G06F 15/16

(52) U.S. Cl. 709/228

(57) ABSTRACT

A fiber channel (FC) storage server includes an optical network access interface and a storage device subsystem. The optical network access interface includes a first FC access module and a first small computer system interface (SCSI) module. The storage device subsystem includes a second FC access module and a second SCSI module. When the optical network access interface receives a connection request packet from an initiator, the first FC access module generates a packet in an SCSI identification format of the storage device subsystem. Further, the storage device subsystem generates a packet in an optical network access interface identification format having a response instruction through the second FC access module and the second SCSI module, and transmits the packet to the optical network access interface to complete the response process.

### BACKGROUND OF THE INVENTION

1. Field of Invention

The present invention relates to a storage device, and more particularly to a fiber channel (FC) storage server.

2. Related Art

The hard disk technology develops quickly, and the hard disk space is expanded from mega byte (MB) to giga byte (GB). With the progress of network technology, even small computer system interfaces (hereinafter referred to as SCSIs for short) are applied in the Internet by some manufacturers. A communication protocol standard of Internet Small Computer Systems Interface (hereinafter referred to as iSCSI for short) is proposed by the IETF to serially connect multiple computer hosts through a TCP/IP communication protocol so as to form a virtual network storage server with a high-speed transmission capability and an expansion/backup capability of unrestrictedly expanding the capacity of a virtual storage equipment. The storage server realized through the iSCSI communication protocol is formed by one or more targets. One-time storage of data is called a session. The party that initiates a session is called an initiator. The initiator sends a request packet to establish a session with the target. The target receives the request packet to respond and establish a session connection.

FIG. 1 is a schematic view illustrating a system architecture of a target in a storage server. When a request packet is to be transmitted to a target 100 through a TCP/IP network, the packet needs to go through an optical network access interface 110, a fiber channel (FC) access module 120, and an SCSI layer 130 before reaching a storage device subsystem 140. The FC access module 120 has an independent executive responsible for resolving an optical network access interface request packet by the optical network access interface 110 so as to obtain an SCSI request instruction or SCSI data. Then, the SCSI request instruction and data are submitted to the SCSI layer 130 to be executed. After the execution is completed, the SCSI layer 130 resolves and submits the SCSI request instruction to the storage device subsystem 140, and waits for an execution result of the storage device subsystem 140. The above layers perform the process switching in a handshake manner, and each layer acts dual roles of a requester and a responder. For example, after the target 100 receives a network packet, the optical network access interface 110 sends out a request packet (or a signal) to notify the FC access module 120 to switch to a role for resolving data of an optical network access interface request packet in the network packet, and the FC access module 120 responds to this request. On receiving the request from the FC access module 120, the SCSI layer 130 executes the resolved SCSI request instruction and data and requests the storage device subsystem 140 to submit the execution result. Under the network environment of massive transmission (high pressure environment), the above handshake processing manner greatly increases the number of process switching. Each connection request has to go through the process switching between the layers. Especially, the FC access module 120, in one aspect, needs to receive a connection request from the lower layer (the optical network access interface 110) and submit the execution result to the upper layer (the storage device subsystem 140), while in another aspect, needs to transmit a response packet (a signal) to respond to the request of the lower layer. Such frequent process switching may result in a bottleneck of the performance of the storage server and reduce the execution speed of the storage server.

### SUMMARY OF THE INVENTION

In order to solve the above problem, the present invention is mainly directed to a fiber channel (FC) storage server realized through an optical network channel.

Therefore, an FC storage server including an optical network access interface and a storage device subsystem is provided. The optical network access interface includes a first FC access module and a first small computer system interface (SCSI) module. The storage device subsystem includes a second FC access module and a second SCSI module. The first FC access module determines whether a received network packet has an optical network access interface request packet. When the network packet has the optical network access interface request packet, the first FC access module resolves the packet to obtain an SCSI request instruction or an SCSI data. The first SCSI module receives and packages the SCSI request instruction or the SCSI data into a packet in an SCSI identification format. The second FC access module is invoked by the storage device subsystem and used for sending a response instruction. The second SCSI module generates a data in an SCSI response format according to the response instruction, packages the data in the SCSI response format into a packet in an optical network access interface identification format, and transmits the packet to the optical network access interface.

As the optical network access interface and the storage device subsystem are respectively built with the FC access module and the SCSI module, the FC access module and the SCSI module can be invoked directly. Thereby, the process switching between the layers is unnecessary, and multiple memory copies between the layers are also avoided as the data does not need to be copied between the layers.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating a system architecture of a target in a conventional storage server;

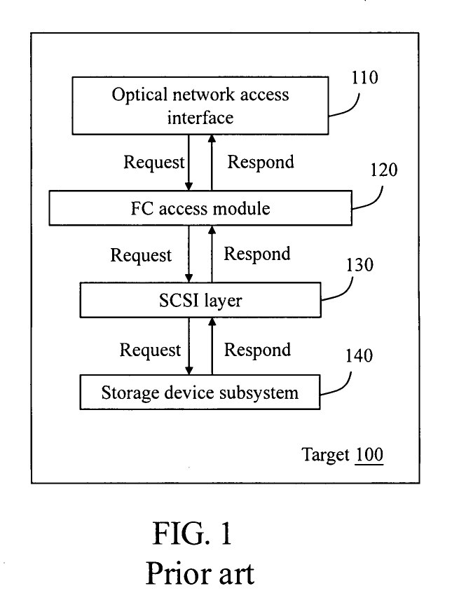

FIG. 2 is a schematic view illustrating a system architecture of a target in a storage server according to a preferred embodiment of the present invention;

FIG. 3 is a flow chart illustrating a processing of a received network packet by an optical network access interface according to a preferred embodiment of the present invention; and

FIG. 4 is a flow chart illustrating a processing of a response instruction by a storage device subsystem according to a preferred embodiment of the present invention.

### DETAILED DESCRIPTION OF THE INVENTION

The objective and method of the present invention are described in detail below with preferred embodiments, and the concept of the present invention may also be applied to other scopes. The embodiments below are only used to illustrate the objective and method of the present invention, instead of limiting the scope of the same.

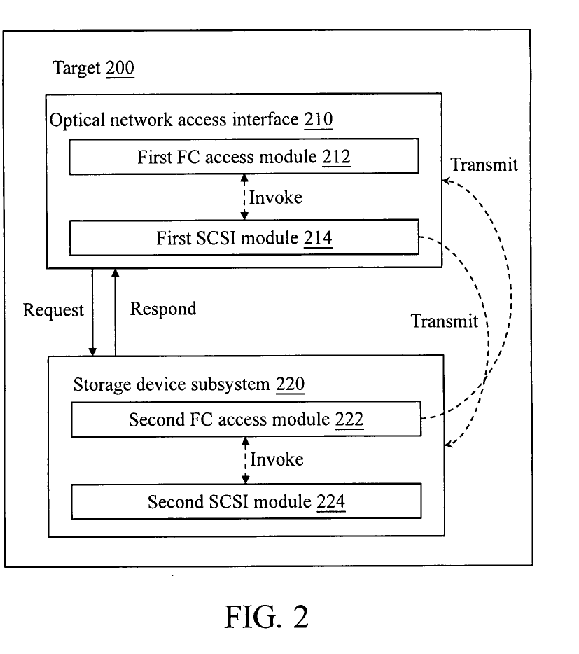

FIG. 2 is a schematic view illustrating a system architecture of a target in a storage server according to a preferred embodiment of the present invention. Referring to FIG. 2, in this embodiment, the storage server realized through an Internet Small Computer Systems Interface (iSCSI) is, for example, formed by one or more targets 200. The target 200 includes an optical network access interface 210 and a storage device subsystem 220. The optical network access interface includes a first fiber channel (FC) access module 212 and a first small computer system interface (SCSI) module 214. The storage device subsystem 220 further includes a second FC access module 222 and a second SCSI module 224.

The optical network access interface 210 receives a network packet transmitted from an initiator, and the network packet is a data packet on a TCP layer. Next, the optical network access interface 210 invokes the first FC access module 212 to determine whether the network packet has an optical network access interface request packet and resolve the packet to obtain an SCSI request instruction or SCSI data encapsulated in the optical network access interface request packet. The optical network access interface request packet is an SCSI packet containing the SCSI request instruction. In this embodiment, for example, it is first determined whether an SCSI header exists in the network packet so as to quickly determine whether the network packet is an SCSI packet, and then the SCSI request instruction or the SCSI data in the SCSI packet is resolved to determine whether the network packet is an optical network access interface request packet. Afterward, the first FC access module 212 invokes the first SCSI module 214 to receive the resolved SCSI request instruction or SCSI data and package the data into a packet in an SCSI identification format. The SCSI module then revokes an interface provided by the storage device subsystem 220 to transmit the packet in the SCSI identification format to the storage device subsystem 220.

As the storage device subsystem 220 is built with the independent second FC access module 222 and the second SCSI module 224, the response instruction can be processed synchronously without waiting for the second FC access module 222 and the second SCSI module 224 to be converted from a requester to a responder. On receiving the above packet in the SCSI identification format, the storage device subsystem 220 determines that a packet in an optical network access interface identification format needs to be returned to the optical network access interface 210 so as to complete the receiving process. Thereby, the storage device subsystem 220 first invokes the second SCSI module 224, and the second SCSI module 224 determines that the storage device subsystem 220 transmits the response instruction. After that, the second SCSI module 224 invokes the second FC access module 222, generates a data in an SCSI response format according to the response instruction, then packages the data in the SCSI response format into the packet in the optical network access interface identification format, and transmits the packet to the optical network access interface 210. In addition, the second FC access module 222 invokes an interface provided by the optical network access interface 210 so as to transmit the packet in the optical network access interface identification format to the optical network access interface 210.

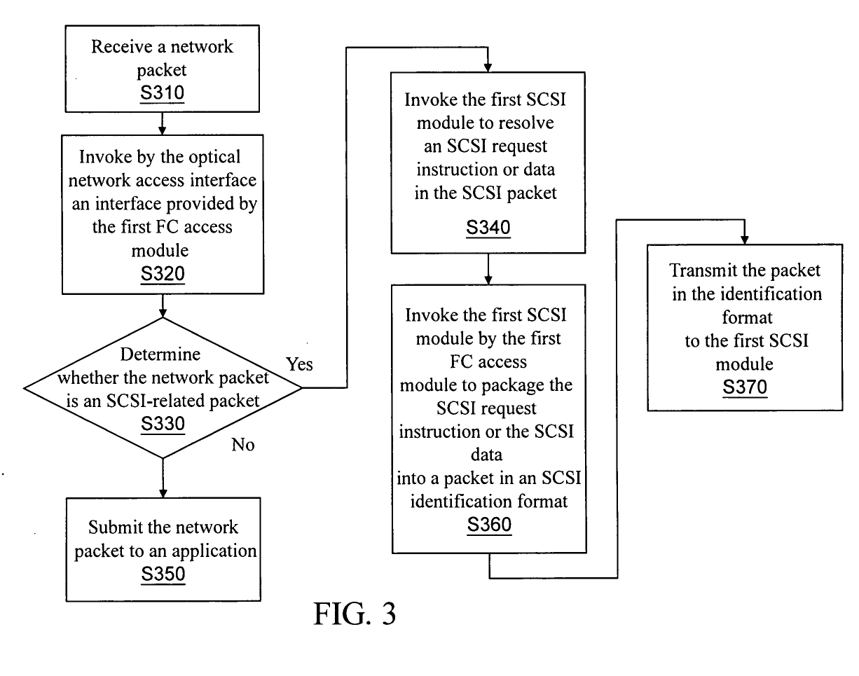

FIG. 3 is a flow chart illustrating a processing of a received network packet by an optical network access interface according to a preferred embodiment of the present invention. In FIG. 3, after the initiator transmits a network packet of a session establishment request, the target receives the network packet (Step S310). Then, the optical network access interface invokes an interface provided by the first FC access module (Step S320), and determines whether the network packet is an SCSI-related packet (Step S330). If the network packet is not an SCSI-related packet (“No” in Step S330), the network packet is submitted to an application (Step S350); otherwise, (“Yes” in Step S330), the first SCSI module is invoked to resolve an SCSI request instruction or data in the SCSI packet (Step S340). Afterward, the first FC access module again invokes the first SCSI module to package the SCSI request instruction or the SCSI data into a packet in an SCSI identification format (Step S360). Finally, the packet in the identification format is transmitted to the first SCSI module (Step S370) to complete the receiving process.

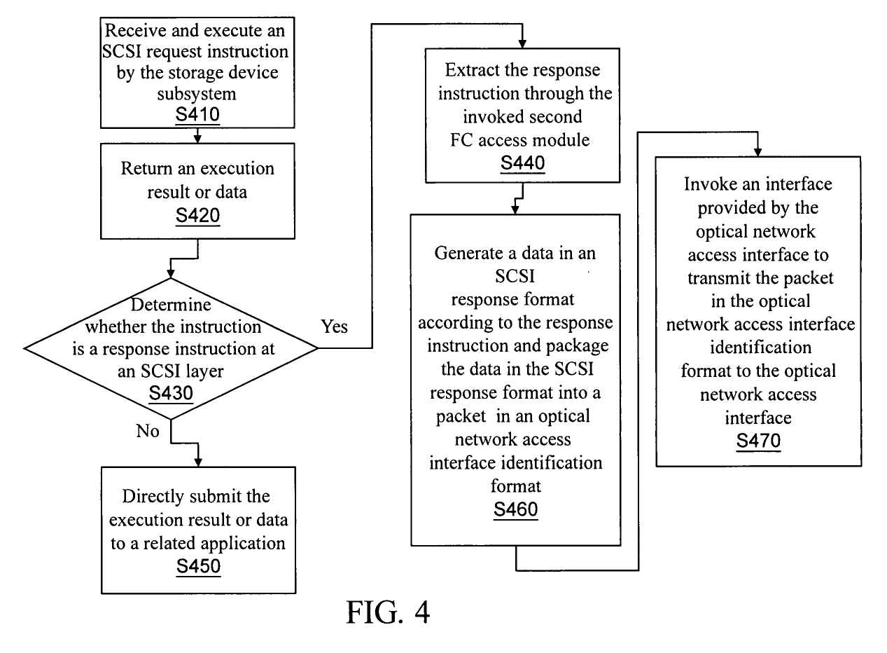

FIG. 4 is a flow chart illustrating a processing of a response instruction by a storage device subsystem according to a preferred embodiment of the present invention. In FIG. 4, the storage device subsystem performs the following steps. First, the storage device subsystem receives and executes an SCSI request instruction (Step S410) and returns an execution result or data (Step S420). Then, the storage device subsystem invokes the second FC access module to determine whether the instruction is a response instruction at an SCSI layer (Step S430), and if yes, extracts the response instruction through the invoked second FC access module (Step S440); otherwise, directly submits the execution result or data to a related application (Step S450). When the second FC access module discovers that the instruction transmitted by the storage device subsystem is not the response instruction, the process enters a network subsystem standard flow and the network subsystem standard flow submits the instruction to the related application. After that, the second FC access module invokes the second SCSI module to generate a data in an SCSI response format according to the response instruction and package the data in the SCSI response format into a packet in an optical network access interface identification format (Step S460), and then invokes an interface provided by the optical network access interface to transmit the packet in the optical network access interface identification format to the optical network access interface (Step S470).

As the optical network access interface and the storage device subsystem are respectively built with the FC access module and the SCSI module, the FC access module and the SCSI module can be invoked directly. Thereby, the process switching between the layers is unnecessary, and multiple memory copies between the layers are also avoided as the data does not need to be copied between the layers.

What is claimed is:

1. A fiber channel (FC) storage server, applied in a Linux system and realized through an optical network channel, comprising:
an optical network access interface, for receiving a network packet transmitted by an initiator, the optical network access interface further comprising:
a first FC access module, for determining that the received network packet has an optical network access interface request packet and resolving the packet to obtain a small computer system interface (SCSI) request instruction or an SCSI data; and
a first SCSI module, for receiving and packaging the SCSI request instruction or the SCSI data into a packet in an SCSI identification format; and
a storage device subsystem, for receiving the packet in the SCSI identification format and returning a packet in an optical network access interface identification format to the optical network access interface to complete the receiving process, the storage device subsystem further comprising:
a second FC access module, invoked by the storage device subsystem, for sending a response instruction; and
a second SCSI module, for generating a data in an optical network access interface response format according to the response instruction, packaging the data in the optical network access interface response format into the packet in the optical network access interface identification format, and transmitting the packet to the optical network access interface.

2. The FC storage server according to claim 1, wherein when determining that the network packet is not the optical network access interface request packet, the first FC access module submits the network packet to an application of a related FC access interface.

3. The FC storage server according to claim 1, wherein when determining that the instruction transmitted by the storage device subsystem is not the response instruction, the second SCSI module directly submits the instruction to a related application.

4. The FC storage server according to claim 1, wherein the second SCSI module further invokes an interface provided by the storage device subsystem so as to transmit the packet in the SCSI identification format to the storage device subsystem.

5. The FC storage server according to claim 1, wherein the second SCSI module further invokes an interface provided by the optical network access interface so as to transmit the packet in the optical network access interface identification format.
